(19) United States
(12) Patent Application Publication
(10) Pub. No.: US 2024/0076013 A1
(43) Pub. Date: Mar. 7, 2024

(54) A SHIP AND A METHOD FOR BRINGING LIQUIFIED GAS FROM AN ONSHORE TERMINAL ACROSS A SEA TO A SUBSURFACE PERMANENT STORAGE RESERVOIR

(71) Applicant: Tore LEA, STAVANGER (NO)

(72) Inventor: Tore LEA, STAVANGER (NO)

(21) Appl. No.: 18/267,212

(22) PCT Filed: Dec. 15, 2021
(86) PCT No.: PCT/NO2021/050265

§ 371 Date: Jun. 14, 2023

(30) Foreign Application Priority Data
Dec. 18, 2020 (NO) 20201398

(51) Int. Cl. B63B 25/16; B63B 27/25; B63B 27/34; B63B 35/44

(52) U.S. Cl. CPC B63B 25/16; B63B 27/25; B63B 27/34; B63B 35/44; B63B 2035/448

(57) ABSTRACT

A ship and a method are for bringing liquified gas, such as liquified carbon dioxide, CO₂, from an onshore terminal for captured gas across a sea to a subsurface permanent storage reservoir. The ship has a loading line for communicating liquified gas from the onshore terminal into at least one vessel, and a processing plant. The processing plant of the ship has an injection processing module configured for injecting liquified gas into the subsurface permanent storage reservoir, wherein the injection processing module is operatively connected to the at least one vessel and an injection line provided with a connector for connecting to a flexible injection hose being in fluid communication with the subsurface permanent storage reservoir.

### CROSS-REFERENCE TO RELATED APPLICATIONS

This application is the U.S. national stage application of International Application PCT/NO2021/050265, filed Dec. 15, 2021, which international application was published on Jun. 23, 2022, as International Publication WO 2022/131926 in the English language. The International Application claims priority of Norwegian Patent Application No. 20201398, filed Dec. 18, 2020. The international application and Norwegian application are both incorporated herein by reference, in entirety

### FIELD

The present disclosure is related to ship-transport of liquified gas. More particularly, the disclosure is related to a ship and a method for bringing liquified gas from an onshore loading terminal across sea to a subsurface permanent storage reservoir. By the term liquified gas is meant any gas which can be made liquid by a process combination of pressure and temperature.

### BACKGROUND

By the term onshore loading terminal is meant herein a terminal configured for transferring a liquified gas from a source of liquified gas on land, and into the ship. During loading, the ship may be moored at a quay, a jetty, or at a loading buoy or similar being in fluid communication with the source of liquified gas. The liquified gas may for example be liquified carbon dioxide (CO₂) that has been captured, liquified and transported to the onshore terminal.

An onshore loading terminal discussed herein may comprise storage tanks for temporarily storing liquified gas on land before being loading the gas onboard the ship, or the onshore loading terminal may be configured for so-called Direct Shuttle Loading (DSL) wherein at least two ships operate in a continuous operation between shore and a location of the subsurface permanent storage reservoir.

In a DSL, one of at least two ships may for a majority of time be moored for example at an onshore jetty, thereby the ship representing a loading terminal for liquified gas to be communicated directly from a transport means on land into the ship. Thus, in operation, a DSL requires that a ship for receiving the gas is available at the onshore loading terminal. However, a DSL does not require land-based tanks for intermediate storage of gas received from a transport means. The transport means may be one or more tanks transported on roads or by railway, or the transport means may even pipelines.

By the term subsurface permanent storage reservoir is meant a reservoir, for example, but not limited to, an abandoned petroleum reservoir having at least one well provided with a closable inlet(s) and capable of providing a sealed enclosure for the gas. At reservoir saturation, the at least one well will be permanently plugged, and the storage reservoir will be permanently abandoned.

In principle, any liquified gas can be injected in a subsurface permanent storage reservoir. However, a liquified gas being of particularly great interest for being injected into a subsurface permanent storage reservoir, is liquified CO₂. For this reason, the invention is described with regards to a ship and a method for bringing liquified CO₂ from an onshore terminal temporarily storing liquified CO₂ that has been captured, liquified and transported to the onshore terminal.

Other liquified gases that may be transported from an onshore terminal across sea to a subsurface permanent storage reservoir are for example, but not limited to, liquified Greenhouse gases such as for example nitrogen oxide (NOx), ozone (O₃), methane (CH₄), fluorinated gases including halogens, liquified petroleum gases (LPG) and liquified noble gases.

CO₂ emissions to the atmosphere is one of the major contributors to global climate challenges. One of the challenges is melting of polar ice caps. NASA has estimated that the polar ice caps are melting 9% every ten years, which is an extremely alarming rate. If the temperature on earth continues to rise at its current rate the Arctic will have no ice by 2040. The Arctic ice cap has decreased since the 1960s by as much as 40%. Emission of CO₂ represents an important negative factor with respect to global environment. The United States Environmental Protection Agency (EPA) estimates that CO₂ represents about 65% of the global greenhouse gas emissions.

Governments have therefore an expressed goal of reducing CO₂ emission. An important contribution for achieving this goal is to develop carbon capture and storage, so called CCS, wherein the CO₂ is captured onshore by industrial CO₂-emitters.

Hitherto it has been possible for a polluter to buy so-called CO₂ quotas which has been preferred in view of an economic perspective. A negative consequence of the possibility of buying CO₂ quotas is that development and implementation of new technology has suffered, while at the same time CO₂-emission is not reduced as required. However, some governments have realized that effective carbon capture technologies are urgently needed and have therefore decided to invest in developing such technologies and fund the implementation of such.

The basis for an international CCS market is The Paris Agreement regarding global warming (signed up by approximately 175 nations) and the EU goal of being carbon neutral by 2050.

According to the UN Climate Panel, the capture, transport, and storage of CO2-emissions from industrial production is a key step in reducing global greenhouse gas emissions. Storage can be done in a sustainable way by using a secure location, for example in an offshore reservoir.

One challenge related to CCS has been related to permanent storage reservoirs. However, there are now several available subsurface permanent storage reservoirs for example in the North Sea, wherein captured CO₂ can be stored in a particular reservoir located 1000-3300 meters below seabed. However, a reservoir suitable for storing captured CO₂ can be located at other depths below seabed than those mentioned above.

In the publication “Northern Lights Project Concept report” Doc. No. RE-PM673-00001 issued by Equinor, it is suggested to transport CO₂ captured and compressed at industrial sources in the Oslofjord region, by means of smaller ships to an onshore terminal on the Norwegian west coast, and from the onshore terminal via a pipeline to an offshore storage complex in the North Sea. By the term “smaller ships” is in this document meant ships having a capacity of carrying up to about 7500 m³ liquid CO₂.

Based on the governments expressed goals to reach the global climate goals of The Paris Agreement, industrial plants for capturing CO₂ are one of a variety of solutions for achieving the global climate goals. In the future when such plants are in operation, a capacity problem for the onshore terminal may arise due to a significant number of ships arriving at the terminal, as well as a limited temporarily storage capacity at the onshore terminal. Another challenge related to projects like the proposed Northern Lights Project, is related to the lack of flexibility related to volume and location of the infrastructure for flowing the CO₂ from the onshore terminal to the subsurface reservoir.

Publication JP2012013146A discloses a flexible tube capable of transporting fluid such as liquified carbon dioxide, and use of the flexible tube when pumping liquified carbon dioxide from a ship to an injection well.

Publication KR2011012356A discloses an LNG ship comprising a storage tank for storing liquified carbon dioxide and at least one pump for pumping the carbon dioxide from the storage tank and directly into an underground storage, without the use of a surface offshore structure being arranged between the ship and the underground storage.

Publication KR20110074056A discloses a method for transporting liquified carbon dioxide from a storage tank of a ship, via a surface platform comprising a pump, and into an underground reservoir.

Publication GB2470122A discloses a subsea high-pressure liquid carbon dioxide storage equipment. The equipment includes a carrier, such as a ship, for holding and carrying high-pressure liquid carbon dioxide; a water-surface power supply equipment arranged on the surface of the water to supply power; a subsea storage equipment having high-pressure liquid carbon dioxide stored therein; a relay flotation tank having high-pressure liquid carbon dioxide stored therein; and an undersea injection pump configured to inject high-pressure liquid carbon dioxide into an undersea storage base and fixedly provided in the seabed. The storage equipment may comprise a buoyancy controller using seawater influx and discharge pumps to regulate the buoyancy of the storage tank. The storage equipment disclosed in GB2470122A is relative complex and costly and must be installed for each undersea storage base.

Publication GB2549001A discloses a method for offshore carbon dioxide based enhanced oil recovery (EOR) or for offshore carbon dioxide based enhanced gas recovery (EGR), wherein CO₂ in the liquid or super-critical state is delivered by at least one carrier vessel from at least one CO₂ storage site to an integrated offshore facility. The offshore facility is provided with at least one on-site storage tank or vessel adapted to store CO₂ in the liquid or super-critical state and equipment for marine transfer of CO₂ in the liquid or super-critical state. The CO₂ must be transferred from the at least one carrier vessel to the offshore facility comprising the at least on-site storage tank, and the method requires the offshore facility in addition to the at least one carrier vessel.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect of the invention, there is provided a ship for bringing liquified gas, such as liquified carbon dioxide (CO₂), from an onshore loading terminal across a sea to a subsurface permanent storage reservoir, the ship comprising a loading line for communicating liquified gas received from the onshore terminal into at least one vessel onboard the ship, and a processing plant. The processing plant comprises:
an injection processing module comprising an injection pump configured for injecting liquified gas into the subsurface permanent storage reservoir;
   wherein the injection processing module is operatively connected to the at least one vessel and a gas injection line provided with a connector for connecting to a flexible injection hose extending from a subsea connection point being connected to a well of the subsurface permanent storage reservoir. The ship is a shuttle tanker comprising a storage tank having a larger volume than the at least one vessel, wherein a portion of the at least one vessel is housed within the storage tank.

The liquified gas may typically be liquified CO₂.

One effect of communicating liquified gas via the injection line with a connector for connecting to a flexible injection hose being in fluid communication with the subsurface permanent storage reservoir is that the captured gas is transported directly from the onshore terminal to the subsurface permanent storage reservoir. By the term directly is meant that the gas is transported to the subsurface permanent storage reservoir without being reloaded via an onshore storage terminal or offshore storage unit. It should be noted that the ship may be loaded with liquified gas collected from more than one onshore terminal at various locations prior to bringing liquified gas across a sea to the subsurface permanent storage reservoir.

The flexible injection hose may be a so-called riser, based on the same technology as utilized for bringing a petroleum product form the reservoir to a ship.

Thus, a great advantage of the present invention is that any intermediate onshore or offshore storage and injection facility between the terminal or terminals and the subsurface permanent storage reservoir, is superfluous. Further, a pipeline from such an intermediate onshore storage facility to the subsurface permanent storage reservoir will also be superfluous. Such a pipeline may be very long. As an example, in the above mentioned “Northern Light” the pipeline will have a length of about 100 km. Such a pipeline is very expensive with respect to both manufacturing costs and installation costs, and costs related to subsequent removal of any non-buried portions of the pipeline after permanently plugging and abandoning a filled-up subsurface permanent storage reservoir.

Thus, the effect of communicating liquified gas, such as for example but not limited to liquified CO₂, from the ship via an injection line provided with a connector for connecting to a flexible injection hose being in fluid communication with the subsurface permanent storage reservoir is that the ship according to the invention replaces extremely expensive infrastructure while at the same time being flexible with respect to collecting captured gas from various future onshore terminals that are expected to arise for example in Europe, and with respect to various subsurface permanent storage reservoirs.

In the petroleum industry, a crude oil shuttle tanker has typically an operating lifetime of about 20 years, whereinafter it is superannuated. However, during its operating lifetime, such a ship is subject to mandatory inspections and maintenance. Thus, even if a crude oil shuttle tanker is superannuated from its intended service, it is oftentimes in a perfect condition for other purposes.

To exploit the valuable resource represented by a superannuated crude oil shuttle tanker, the inventor has found that it can be adapted for use as an injection-ship according to the present invention.

The processing plant may further comprise a liquifying processing module configured for liquifying gas, wherein the at least one vessel is in loop communication with the liquifying processing module so that gas evaporated from the liquified gas within the at least one vessel is liquified in the liquifying processing module and communicated back into the at least one vessel.

The effect of liquifying gas evaporated from the liquified gas within the at least one vessel and communicating the liquified gas back into the at least one vessel, is that the evaporated gas is recirculated back into the vessel, thereby avoiding gas emission for example during loading at the onshore terminal and/or during voyage from the onshore terminal to the subsurface permanent storage reservoir. Without such a recirculation, as much as 10-15% of the gas load may be lost through evaporation through the transport value chain, i.e., during loading, transport, and injection.

In one embodiment, the at least one vessel may comprise a first portion and a second portion, wherein the first portion extending above a main deck of the ship, and wherein pipes for communicating gas from the at least one vessel to the process plant are connected to the first portion. The effect of this is that for example a superannuated shuttle tanker can be adapted to its new service purpose substantially without any intervention of the structure of the ship.

Preferably, the second portion of the at least one vessel extends into the tank having a larger volume than the at least one vessel. Said tank may be a previous petroleum, typically crude oil, storage tank of a shuttle tanker. Thus, in such an example of utilizing a superannuated shuttle tanker, apart from providing an aperture in said tank for receiving the second portion of the gas vessel, the originally installed storage tank remains in place.

In a preferred embodiment, the at least one vessel comprises a plurality of vessels extending into the larger volume tank. Thus, the plurality of vessels may form a cluster of vessels within said tank. In one embodiment, the ship may comprise a plurality of said larger volume tank. Thus, the gas transport capacity of the ship may be scalable to meet specific needs from a few thousands m³ as suggested in the “Northern Lights Project Concept report” mentioned above, to more than 100.000 m³.

In a preferred embodiment, the at least one vessel is oblongness, i.e., having a tubular form, wherein a longitudinal axis of the vessel may be substantially perpendicular to a surface of the main deck of the ship. This has the effect of minimizing a surface area of the liquified gas from which gas may evaporate, while at the same time facilitating connection of piping arrangements communicating with the on-board process plant.

When arriving at the location of the subsurface permanent storage reservoir, the ship must be kept at a relatively exact position. In shallow water, for example less than 200 m, the ship may be kept in position by means of a free weathervaning anchoring system. However, in deeper water, for example more than 200 m, keeping a ship in position by means of an anchoring system, may be impractical or even impossible. It is therefore an advantage if the ship is provided with a Dynamic Positioning System (DPS). A DPS is a computer-controlled system to automatically maintain a ship's position and heading by using its own propellers and thrusters. Position reference sensors, combined with wind sensors, motion sensors and gyrocompasses provide information to the computer pertaining to the ship's position and the magnitude and direction of environmental forces affecting its position. Preferably, the ship is provided with both a Dynamic Positioning system DPS and an anchoring system allowing for free weathervaning.

In one embodiment is the ship according to the invention a superannuated shuttle tanker, wherein a portion of the at least one vessel is housed within a storage tank originally installed in the shuttle tanker.

In a second aspect the invention there is provided a method for bringing liquified gas, such as liquified carbon dioxide (CO₂), across a sea from an onshore terminal gas, to a subsurface permanent storage reservoir, the method comprising:
transferring the liquified gas from the onshore terminal to a ship according to the first aspect of the invention;
bringing the ship to and positioning the ship with respect to an inlet of the subsurface permanent storage reservoir;
providing fluid communication between the at least one vessel of the ship and the inlet of the subsurface permanent storage reservoir; and
injecting the liquified gas from the at least one vessel into the permanent subsurface storage reservoir by means of the injection processing module of the process plant.

The method may further comprise providing the process plant with a liquifying processing module configured for liquifying gas, the liquifying processing module configured for being set in loop communication with the at least one vessel for re-liquifying gas evaporated from the liquified gas within the at least one vessel.

The liquifying processing module may be in operation during loading of the liquified gas into the at least one vessel. Additionally, or alternatively to, operating the liquifying processing module during loading, the liquifying processing module may be in operation during voyage across sea from the onshore terminal to a location of the subsurface permanent storage reservoir.

Preferably, re-liquifying of the evaporated gas by means of the liquifying processing module commences at start of or during loading of the liquified gas into the at least one vessel.

In a preferred embodiment, the positioning of the ship with respect to the inlet of the subsurface permanent storage reservoir is provided by means of dynamic positioning. A positioning of the ship is may alternatively, or additionally, be provided by means of a free weathervaning anchoring system. A combination of positioning the ship by means of a DPS and a free weathervaning anchoring system, may be advantageous with respect to reducing the use of the propellers, and thereby reducing gas emission from the combustion engine(s) of the ship.

Preferably, providing fluid communication between the at least one storage vessel and the inlet of the subsurface permanent storage reservoir comprises connecting an injection line of the ship to an upper end portion of a flexible injection hose configured for communicating fluid through the inlet of the subsurface permanent storage reservoir. The injection line of the ship may typically be connected to the flexible injection hose by means of a submerged loading buoy or a catenary anchor leg mooring or similar connection mechanisms allowing for communication of fluid from the ship 1 to the seabed SB.

In a third aspect of the invention a superannuated crude oil shuttle tanker adapted for bringing liquified gas, such as liquified CO₂, from an onshore terminal for captured gas directly to a subsurface permanent storage reservoir, is used as the ship according to the first aspect of the invention.

### BRIEF DESCRIPTION OF THE DRAWINGS

In the following is described examples of preferred embodiments illustrated in the accompanying drawings, wherein:

FIG. 1a shows a principle drawing of a ship in a loading state at an onshore terminal, and a subsequent reservoir injecting state wherein the ship is operatively connected to a subsurface permanent storage reservoir;

FIG. 1b shows in larger scale a principle drawing of the ship in FIG. 1a being in the reservoir injecting state;

FIG. 2a shows in larger scale a principle drawing of a side view of the ship;

FIG. 2b shows the ship in FIG. 1 seen from above;

FIG. 2c shows in larger scale detail A of FIG. 2a; and

FIG. 3 shows a simplified process outline of an embodiment of the invention.

### DETAILED DESCRIPTION OF THE DRAWINGS

In the description, positional indications such as for example above, below, right, refer to the position shown in the figures.

Same or corresponding elements are indicated by same reference numerals. For clarity reasons some elements may in some of the figures be without reference numerals.

A person skilled in the art will understand that the figures are just principle drawings. The relative proportions of individual elements may also be strongly distorted.

The examples are related to a liquified gas in the form of captured CO₂ that has been captured and liquified by CO₂ emitters and that has been transported to the onshore terminal. However, it should be noted that the liquified gas may be other liquified gases as mentioned above wherein there may be a desire of permanently safe storage in a subsurface reservoir.

In the figures, the reference numeral 1 indicates a ship according to the invention. In the embodiment shown, the ship, here shown as a tanker 1, comprises compartments 3 wherein each compartment 3 houses a plurality of vertical vessels 5 arranged adjacent each other and configured for holding liquified carbon dioxide (CO₂).

A first portion of the vertical vessels 5 extends above a main deck 7 of the ship, while a second portion of the vertical vessels 5 is housed within the compartments 3.

In the embodiments shown, the ship 1 is a superannuated crude oil shuttle tanker designed with crude oil storage tanks that are modified to form the compartments 3 for housing the CO₂ vessels 5. The originally designed storage tanks are modified by providing opening or openings for the top portion of the CO₂ vessels 5. The rest of the storage tanks that form the compartments 3 of the ship or tanker 1 according to the invention, are maintained substantially as designed for the superannuated crude oil shuttle tanker. Therefore, substantially no redesign of the load carrying structure of the superannuated crude oil tanker is required.

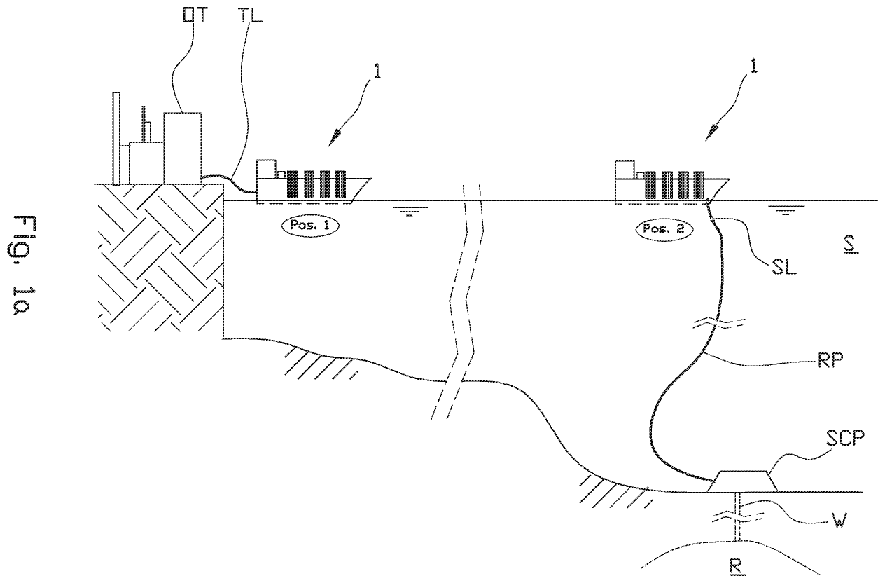

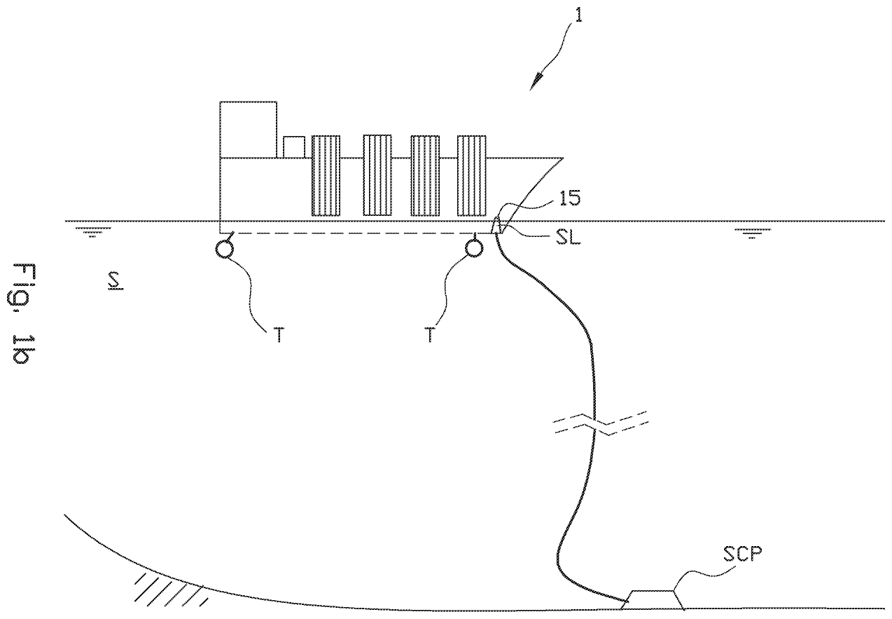

FIG. 1a shows a principle drawing of a ship 1 being in a loading state at an onshore terminal OT for captured CO₂ (indicated as Pos. 1 in the figure), and in a subsequent reservoir injecting state (indicated as Pos. 2 in the figure) wherein the ship 1 has moved across the sea S and is operatively connected to a subsurface permanent storage reservoir R via a Subsea Connection Point (SCP) to a well W for the subsurface permanent storage reservoir. However, the principle shown in FIG. 1 may also be applicable for a so-called Direct Shuttle Loading (DSL) wherein a first ship (indicated as Pos. 1 in FIG. 1a) is moored at a loading jetty (not shown), and a second ship (indicated as Pos. 2 in FIG. 1a). In said DSL, the first ship and second ship are operated in a substantially continuous operation between the loading jetty and the location of the subsurface permanent storage reservoir.

A person skilled in the art will appreciate that the Subsea Connection Point may be operatively connected to a plurality of wells. The subsurface permanent storage reservoir R is in the embodiment shown an abandoned petroleum reservoir. The SCP is operatively connected to a flexible injection hose RP wherein an end portion of the flexible injection hose RP is provided with a submerged loading buoy SL. In an inactive position, the submerged loading buoy SL floats in an equilibrium position approximately 30-50 meters below sea level. The submerged loading buoy SL is moored to a seabed SB by means of anchor lines (not shown).

As an alternative to connecting the ship 1 to the subsurface permanent storage reservoir R via a submerged loading buoy SL, the ship 1 may be connected to the subsurface permanent storage reservoir R via a catenary anchor leg mooring (CALM) or similar connection mechanisms allowing for communication of fluid from ship 1 to seabed SB.

In the reservoir injecting state (Pos. 2 to the right in FIG. 1a), the ship 1 is kept at a desired position by means of a Dynamic Positioning System DPS to automatically maintain the ship's position and heading by using its own propellers and thrusters T as indicated in FIG. 1b. It should be noted that prior to commencing the injection of the CO₂, the submerged loading buoy SL shown in FIG. 1a is operatively connected to the ship 1 as shown in FIG. 1b.

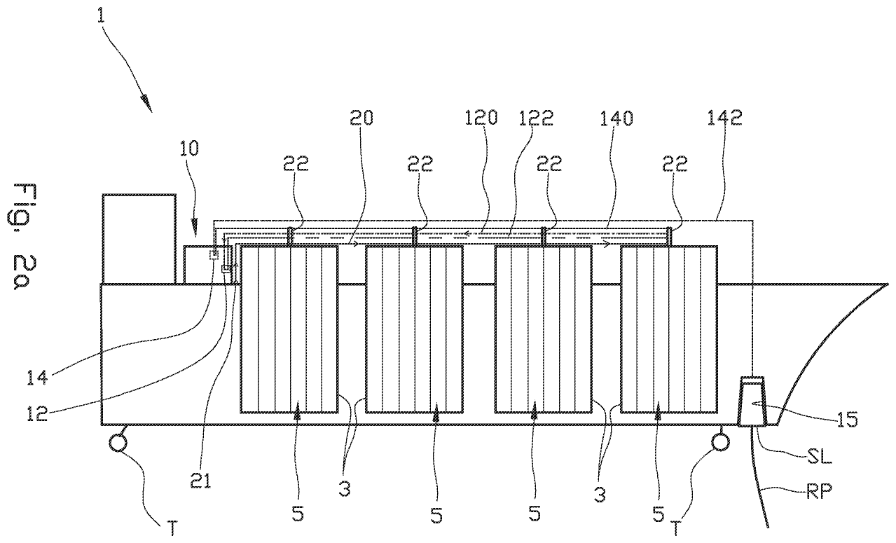

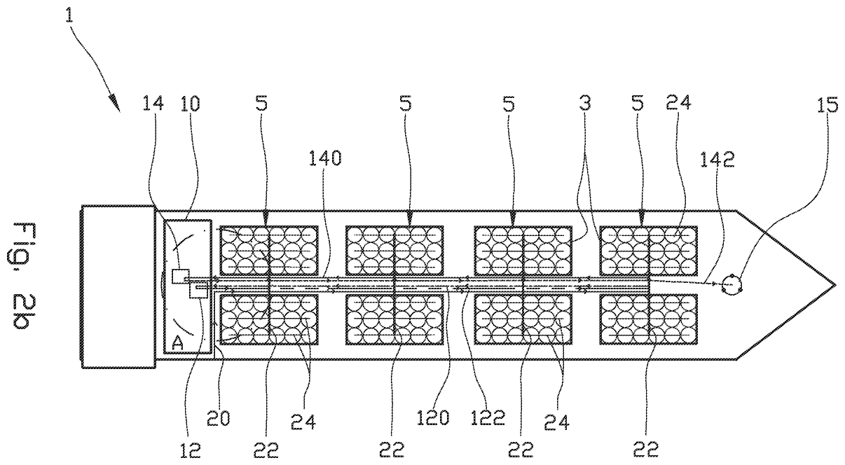

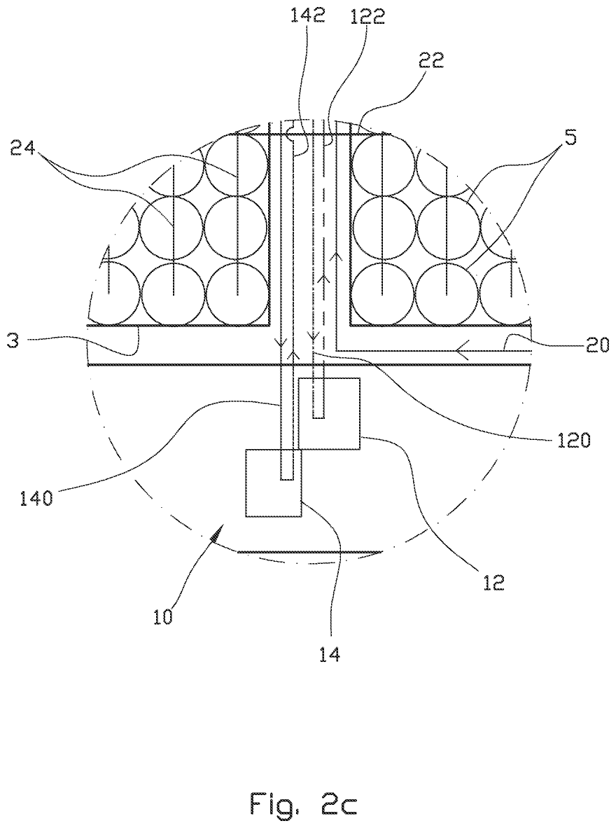

Turning now to FIGS. 2a-2c, the ship 1 is provided with a compartment 15 at a bow of the ship 1. The compartment 15 comprises a conical recess and lifting appliances (not shown) for lifting the submerged loading buoy SL into the compartment 15 and securing the loading buoy SL within the compartment (see FIG. 1b) as will be appreciated by a person skilled in the art.

The ship 1 comprises a loading line 20 having connector 21 for connecting to a terminal loading line TL (see FIG. 1a). The loading line 20 is connected to distribution manifolds 22 operatively connected to each vessel 5 (ninety-six shown in FIG. 2b) via submanifolds 24, one for each row of vessels 5 within each cluster of vessels 5 defined by the each of the six compartments 3 shown in FIG. 2b.

The manifolds 22 and submanifolds 24 comprises four parallel pipeline systems as will be explained below.

The loading line 20 discussed above is connected to the vessels 5 via loading pipelines forming a first pipeline system of the manifolds 22 and submanifolds 24.

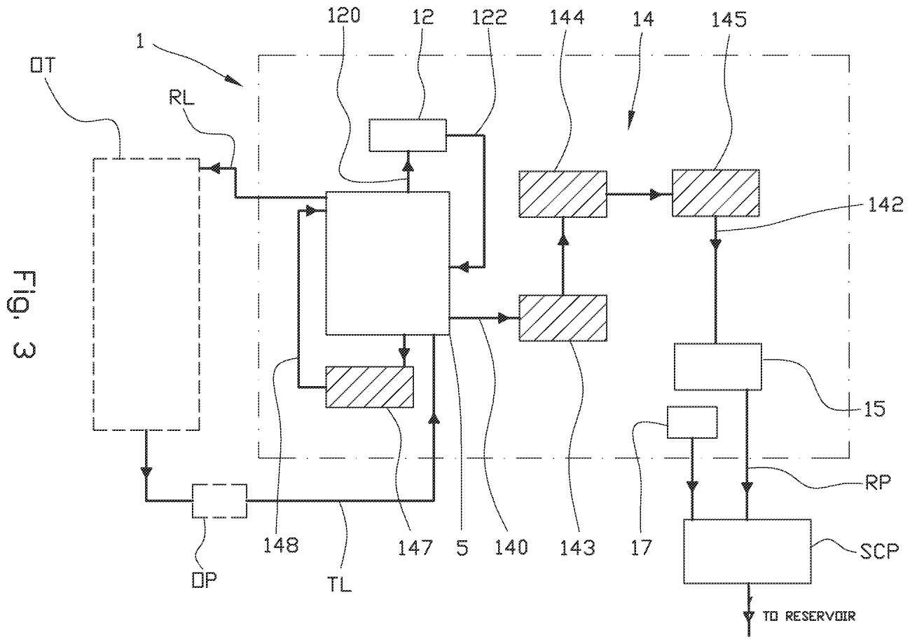

The ship 1 further comprises a processing plant 10. The processing plant 10 comprises a liquifying processing module 12 configured for liquifying gaseous CO₂, and an injection processing module 14 configured for injecting liquified CO₂ into the subsurface permanent storage reservoir R. Injection pumps (see FIG. 3) of the injection processing module 14 are configured for an injection pressure adapted to a pressure in the subsurface permanent storage reservoir R.

During loading of the liquified CO₂ from the onshore terminal OT, and until the CO₂ is injected into the subsurface permanent storage reservoir, some of the liquified CO₂ will undergo a phase change from liquified state to gas state, i.e., some of the CO₂ will evaporate.

Instead of releasing the CO₂ to the atmosphere, the evaporated CO₂ is communicated into the liquifying processing module 12 configured for liquifying gaseous CO₂ via a degassing line 120 operatively connected to each of the vessels 5 via degassing pipelines forming a second pipeline system of the manifolds 22 and submanifolds 24. In the liquifying processing module 12, the gaseous CO₂ is reliquefied and returned to the vessels 5 via a return conduit 122 and degassing return pipelines forming a third pipeline system of the manifolds 22 and submanifolds 24. Thus, degassing line 120 and the return conduit 122 is arranged in a loop comprising the vessels 5 and the processing module 12. The liquifying processing module 12 comprises a pressure increasing device and a cooling element known per se.

The injection processing module 14 of the process plant 10 is operatively connected to the vessels 5 via an injection module supply line 140. The injection module supply line 140 is operatively connected to each of the vessels 5 via injection supply pipelines forming a fourth pipeline system of the manifolds 22 and submanifolds 24. In the injection processing module 14, the liquified CO₂ is further pressurised and heated by a heating element before it is communicated into an injection line 142 and into the subsurface permanent storage reservoir R (see FIG. 1a) via the buoy SL and the flexible injection hose RP. The injection line 142 bypasses the manifolds 22 as best seen in FIG. 2c.

The liquified CO₂ flowing in the injection line 142 may typically be heated to a temperature of for example 4° C. to avoid formation of ice plugs in the injection line 142 and in the flexible injection hose RP. The heating element of the injection processing module may comprise a heat exchanger. Such a heat exchanger may be configured for heat exchange with for example sea water or exhaust from a combustion engine of the ship 1.

From the above it should be appreciated that a length of the flexible injection hose RP is extremely limited as compared with an injection pipeline running from an onshore terminal to an inlet of a subsurface permanent storage reservoir as suggested in the “Northern Lights Project Concept Report” mentioned above. Further, a ship bringing the captured CO₂ to a position above a subsurface permanent storage reservoir R is flexible in that no new pipeline infrastructure has be installed in the seabed when a storage reservoir has been saturated and a new subsurface permanent storage reservoir is required.

Due to the liquifying processing module 12 of the ship 1, the ship 1 may be in a “standby” position relatively nearby the relevant storage reservoir for several days without losing any of the CO₂ load caused by evaporation of the liquified CO₂. Keeping the ship 1 in a standby position may be necessary for example due to harsh weather conditions or a que of ships waiting for access to the submerged loading buoy SL.

Turning now to FIG. 3 showing a process outline for the process from an onshore terminal OT, via the ship 1 to the subsurface connection point SCP operatively connected to for example, but not limited to, a submerged loading buoy SL as shown in FIGS. 1a-2b, or a catenary anchor leg mooring (CALM) or similar connection mechanisms allowing for communication of fluid from ship 1 to seabed SB.

In FIG. 3, elements forming part of the ship or tanker 1, is indicated within dash-dot lines. Further, elements forming part of the injection module 14 are indicated by hatching.

The liquified CO₂ is transferred from one or more tanks of an onshore terminal OT, via terminal loading line TL, to the at least one vessel 5 of the ship 1. The terminal loading line TL comprises a loading line pump OP. The CO₂ may in this stage have a pressure of for example 15 bar and a temperature of −25° C. An equalisation line RL extends from the vessel 5 to the tanks of the onshore terminal OT so that the volume of the liquified CO₂ pumped out of the onshore terminal tanks is compensated by evaporated CO₂ from the vessel 5 of the ship 1.

After finishing loading of the CO₂ into the vessel 5, the loading line TL and the equalization line RL are disconnected from the ship 1 whereinafter the ship 1 starts its crossing to a location of the subsurface permanent storage reservoir.

At the location of the subsurface permanent storage reservoir, the vessel 5 of the ship 1 is operatively connected to the subsurface permanent storage reservoir via a floating buoy system.

The floating buoy system may be a CALM (catenary anchor leg mooring) buoy, or an anchor moored submerged loading buoy, including a swivel, which will allow for free weathervaning of the ship when connected. The selection of buoy system will depend on water depth and weather conditions on location. Thus, in FIG. 3, the reference numeral 15 indicates a connection point between the flexible injection hose RP and the ship 1.

When commencing the injection operation, the injection module 14 is activated. The injection module 14 comprises a transfer pump 143 configured for increasing the pressure of the liquified CO₂ flowing into a heater 144. In the heater 14, the pressure may be for example 50 bar. The heater 144 is configured for increasing the temperature of the liquified CO₂ to avoid phase transition of the CO₂ from liquified state to solid state when flowing through the flexible injection hose RP and the subsea connection point SCP. The temperature of the liquified CO₂ flowing out of the heater 144 is adapted to an ambient temperature of the flexible injection hose RP at a lower end portion thereof, and an injection pressure provided by an injection pump 145 arranged downstream of the heater 144. The injection pressure is adapted to a pressure within the subsurface reservoir. The liquified CO₂ being injected may for example have a temperature of 4° C. and a pressure of 120 bar.

The process outline shown in FIG. 3 further comprises a vaporization unit 147 arranged in a loop 148 operatively connected to an outlet and an inlet of the vessel 5. The vessel 5 may comprise a plurality of vessels as shown in FIGS. 1a-2c. The purpose of the vaporization unit 147 is to compensate for the volume of liquified CO₂ being injected into the reservoir, and thus maintaining the desired pressure within the vessel 5 (or vessels).

The process outline shown in FIG. 3 further comprises a liquifying processing module 12 forming part of the processing plant 10. The liquifying processing module is configured for liquifying gaseous CO₂ evaporating from the vessel 5 during loading of the liquified CO₂, and during transport from the onshore terminal OT and until the process of injecting the liquified CO₂ into the subsurface permanent storage reservoir R commences. The CO₂ liquified by means of the liquifying processing module 12 is communicated back into the vessel 5 via return conduit 122. Thus, substantially no load is lost.

The ship 1 may further comprise a control system 17 known per se for controlling a wellhead control package comprising subsea valves and the well of the subsurface permanent storage reservoir R. The control system 17 is configured for supplying hydraulic power, monoethylenglycol (MEG), electrical power and signals to the wellhead. The hydraulic power may be provided by means of a water based hydraulic power system being in fluid communication with ambient water. The control system 17 is further operatively connected to a chemical injection line 17′ for injecting for example monoethylenglycol into the subsea connection point SCP and the flexible injection hose RP prior to disconnecting the ship from the flexible injection hose RP so that the flexible injection hose and subsea connection point is prepared for a new load of CO₂.

In an alternative embodiment (not shown) a control system corresponding to the system 17 discussed above, may be arranged separately from the ship 1, for example from a distant offshore platform operatively connected to the subsea connection system SCP.

A person skilled in the art will appreciate that any subsea connection point provided with a flexible injection hose must be provided with an emergency system being activatable in the event of emergency disconnect from a ship operatively connected to a flexible injection hose. An emergency disconnect will typically occur in a situation wherein the ship is subject to an uncontrolled drive- or drift-off. For a flexible injection hose configured for receiving liquified CO₂, such an emergency system will be configured for operating independently of the ship and will comprise an accumulator and a reservoir containing an antifreeze agent to maintain pressure in the flexible injection hose when disconnecting from the ship in case of an emergency.

From the disclosure herein, it will be appreciated that the present invention has great advantages as compared with prior art solutions. No re-loading of liquified CO₂ collected from an onshore terminal OT is required as the ship 1 brings the collected CO₂ directly to a location above the subsurface permanent storage reservoir R wherein the ship 1 is connected to a flexible injection hose RP. Thus, apart from a flexible injection hose RP, subsea structures, and an appurtenant connection point, no additional onshore or offshore injection facility and infrastructure is required between the onshore terminal OT and the subsea connection point SCP. The invention therefore represents a cost-effective alternative, while at the same time representing a limited CO₂-footprint. The system is flexible as regards various subsurface permanent storage reservoir.

It should be noted that the fluid flow within the lines, conduits and manifolds are controlled by means of pumps and valves which are controlled from a control room of the ship.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A ship for bringing liquified gas, such as liquified carbon dioxide, CO₂, from an onshore terminal across a sea to a subsurface permanent storage reservoir, the ship comprising a loading line for communicating liquified gas received from the onshore terminal into at least one vessel onboard the ship, and a processing plant, wherein the processing plant comprises:
an injection processing module comprising an injection pump configured for injecting liquified gas into the subsurface permanent storage reservoir;
wherein the injection processing module is operatively connected to the at least one vessel and a gas injection line provided with a connector for connecting to a flexible injection hose extending from a subsea connection point being connected to a well of the subsurface permanent storage reservoir, wherein the ship is a shuttle tanker comprising a storage tank having a larger volume than the at least one vessel, wherein a portion of the at least one vessel is housed within the storage tank.

2. The ship according to claim 1, wherein the processing plant further comprises a liquifying processing module configured for liquifying gas, wherein the at least one vessel is in loop communication with the liquifying processing module so that gas evaporated from the liquified gas within the at least one vessel is liquified in the liquifying processing module and communicated back into the at least one vessel.

3. The ship according to claim 1, wherein the at least one vessel comprises a first portion and a second portion, the first portion extending above a main deck of the ship, and wherein pipes for communicating gas from the at least one vessel to the process plant are connected to the first portion of the at least one vessel.

4. The ship according to claim 3, wherein the second portion of the at least one vessel extends into the storage tank having a larger volume than the at least one vessel.

5. The ship according to claim 4, wherein the at least one vessel comprises a plurality of vessels extending into the storage tank.

6. The ship according to claim 1, wherein the at least one vessel being oblongness, wherein a longitudinal axis of the vessel is substantially perpendicular to a surface of a main deck of the ship.

7. The ship according to claim 1, wherein the ship is provided with at least one of a Dynamic Positioning System and an anchoring system allowing for free weathervaning.

8. The ship according to claim 1, wherein the ship is a superannuated shuttle tanker, wherein a portion of the at least one vessel is housed within a storage tank originally installed in the shuttle tanker.

9. A method for bringing liquified gas, from an onshore terminal, across a sea to a subsurface permanent storage reservoir, the method comprising:
transferring the liquified gas from the onshore terminal to a ship according to claim 1, wherein the method further comprises:
bringing the ship to and positioning the ship with respect to an inlet of the subsurface permanent storage reservoir;
providing fluid communication between the at least one vessel of the ship and the inlet of the subsurface permanent storage reservoir; and
injecting the liquified gas from the at least one vessel into the permanent subsurface storage reservoir via the injection processing module of the process plant.

10. The method according to claim 9, further comprising providing the process plant with a liquifying processing module configured for liquifying gas, the liquifying processing module configured for being set in loop communication with the at least one vessel for re-liquifying gas evaporated from the liquified gas within the at least one vessel.

11. The method according to claim 9, wherein the positioning of the ship with respect to the inlet of the subsurface permanent storage reservoir is provided by dynamic positioning.

12. The method according to claim 9, wherein the positioning of the ship with respect to the inlet of the subsurface permanent storage reservoir is provided by a free weathervaning anchoring system.

13. The method according to claim 9, wherein providing fluid communication between the at least one vessel and the inlet of the subsurface permanent storage reservoir comprises connecting an injection line of the ship to an upper end portion of a flexible injection hose configured for communicating fluid through the inlet of the subsurface permanent storage reservoir.

14. A method comprising using a superannuated crude oil shuttle tanker adapted for bringing liquified gas from an onshore terminal for captured gas directly to a subsurface permanent storage reservoir.
